(19) United States
(12) Patent Application Publication
(10) Pub. No.: US 2022/0063437 A1
(43) Pub. Date: Mar. 3, 2022

(54) METHOD AND DRIVER ASSISTANCE SYSTEM FOR PREDICTING THE AVAILABILITY OF A CHARGING STATION FOR A VEHICLE

(71) Applicant: JOYNEXT GmbH, Dresden (DE)

(72) Inventors: Matthias FISCHER, Dresden (DE); Robert BÜRGER, Dresden (DE)

(73) Assignee: JOYNEXT GmbH, Dresden (DE)

(21) Appl. No.: 17/410,603

(22) Filed: Aug. 24, 2021

(30) Foreign Application Priority Data
Aug. 27, 2020 (DE) 102020005262.2

(51) Int. Cl. B60L 53/63; B60L 53/66

(52) U.S. Cl. CPC B60L 53/63; B60L 53/66

(57) ABSTRACT

A method for predicting the availability of a charging station for a vehicle with a driver assistance system is provided. The method includes establishing an expected time of arrival of the vehicle at the charging station LS, and determining an expected availability of the charging station at the time of arrival, wherein at least one user feedback about the correctness of a prediction of the availability of the charging station in the past is taken into account. Moreover, a driver assistance system for carrying out the method is provided.

The disclosure relates to a method and a driver assistance system for predicting the availability of a charging station for a vehicle.

Because of the long charging times of batteries of electrically powered vehicles and the small number of charging stations, the availability of vacant charging stations constitutes an enormously influential factor with respect to the travel time in the case of routes with several charging stops. Poor availability of charging stations may extend the travel time along a route by several hours. Moreover, a waiting line at a charging station may further extend the travel time.

The mere information of whether a charging station is occupied or vacant permits deductions concerning the actual travel time to be made only in the event it is not occupied, and also is relevant only in the case of an immediate desire for charging.

It is an object of the disclosed embodiments, to improve the prediction of the availability of a charging station for a vehicle.

According to the disclosed embodiments, the object is achieved with a method for predicting the availability of a charging station for a vehicle according to claim 1. Moreover, the object is achieved with a driver assistance system for predicting the availability of a charging station for a vehicle according to patent claim 10.

Further developments of the disclosed embodiments are the subject matter of dependent patent claims.

The method according to the disclosed embodiment is carried out with a driver assistance system and includes the following method steps:
establishing an expected time of arrival of the vehicle at the charging station, and
determining an expected availability of the charging station at the time of arrival, wherein a user feedback about the correctness of a prediction of the availability of the charging station in the past is taken into account.

By taking into account the user feedback, the practical experience of a user the latter has had with a prediction concerning the availability of the charging station is being included in the current prediction. Thus, the current prediction can be optimized, so that the availability of the charging station is predicted particularly well. Moreover, a lack of currentness of other information or data that are also taken into account when determining the expected availability can thus be compensated.

The vehicle may be, among other things, a land vehicle, an water vehicle, an aircraft or a robot that can be moved along a path. Moreover, instead of electric energy or electrical power, fuel may also be taken on or stocked up on at the charging station, e.g. diesel, gasoline, liquid gas or hydrogen. In this case, the charging station is a gas station.

The charging station may be deemed available for the vehicle if the charging of the drive energy storage of the vehicle can be started immediately. This requires the charging station to be operational and not to be occupied or blocked by any other vehicle.

The user feedback may have been manually input into the driver assistance system, e.g. by a user of the vehicle. The user may have used an input unit of the vehicle and/or an internet portal for this purpose. Alternatively, the user feedback also may have been input into the driver assistance system by a user of different vehicle, e.g. via an internet portal.

Instead of only a single user feedback, several user feedbacks may also be taken into account when determining the expected availability of the charging station.

The expected availability of the charging station may include a piece of information about whether or not the charging station will be available to or vacant for the vehicle at the time of arrival. Alternatively, the expected availability of the charging station may include a probability of availability representing a probability for the charging station being available to or vacant for the vehicle at the time of arrival.

The expected availability of the charging station may be outputted to a user of the driver assistance system, e.g. to a driver of the vehicle. In addition or alternatively, the availability of the charging station may be outputted to a navigation system. This makes it possible to plan a route with the navigation system, with the expected availability of the charging station being taken into account.

The method may be carried out for several charging stations, e.g. separately for each of the charging stations. The charging stations may be located along an expected route of the vehicle. In this case, a travel time of the vehicle along the route can be estimated taking into account the determined expected availabilities of the charging stations.

In one embodiment, one or more of the following pieces of availability information are evaluated when determining the expected availability of the charging station:
an expected route and a charging state of another vehicle,
a current occupancy of the charging station,
a number of vehicles waiting at the charging station,
a waiting time of a vehicle at the charging station in the past,
a staying time of a vehicle at the charging station in the past,
a charging speed of the charging station,
a number of charging points of the charging station.

Consequently, vehicle data (expected route, charging state, waiting time, staying time) and charging station data (occupancy, number of vehicles, charging speed, number of charging points) can be evaluated. These pieces of availability information may be obtained from a center, e.g. from a central server. Alternatively, the pieces of availability information may be obtained from a data cloud service (cloud service). Analogously, the user feedback may also be obtained from a center or a data cloud service.

The waiting time of a vehicle at a charging station is understood to be a period of time that elapses between the arrival of the vehicle at the charging station and the charging station becoming vacant, so that the charging of the vehicle or of its drive energy storage can be started. Positional data, route information, charging states and remaining range of a vehicle may be used for identifying the state of “waiting”.

The staying time of a vehicle at a charging station is understood to be a period of time that elapses between the arrival of the vehicle at the charging station and the completion of the charging of the vehicle or of its drive energy storage at the charging station.

Instead of vehicle data of only a single vehicle, vehicle data of several vehicles may also be evaluated. In particular, an average waiting time of the waiting times of several vehicles may be evaluated instead of the waiting time of only a single vehicle.

In another embodiment, the user feedback includes a piece of information about whether the charging station was available at a point in time at which the charging station was supposed to be available according to the prediction. The user has typically arrived at the charging station at such a point in time, so that they were able to compare the prediction to the real situation.

In this case, the user feedback may have the following effect on the expected availability to be determined: if the information is that the charging station was not available at the point in time, a probability of availability, which is a constituent element of the expected availability, may be lowered, e.g. by a predetermined amount or a predetermined factor.

In another embodiment, the user feedback includes a waiting time between a point in time at which the charging station, contrary to the prediction, was occupied, and a later point in time at which the charging station became available. The user has typically arrived at the charging station at the first point in time.

In particular, the user feedback may include an unexpected waiting time between the arrival of a vehicle at the charging station and the charging station becoming vacant. If several such waiting times were reported, e.g. by several users, an average waiting time of the waiting times may be established and taken into account when determining the expected availability of the charging station.

In another embodiment, the expected availability of the charging station includes an expected waiting time between the time of arrival and a later point in time at which the charging station is expected to become available or vacant. That means that this waiting time is a constituent element of the expected availability.

In this case, the user feedback may have the following effect on the waiting time: if the user feedback includes a piece of information that the charging station was not available at a point in time at which the charging station was supposed to be available according to the prediction, then the waiting time (which is a constituent element of the expected availability) can be extended, e.g. by a predetermined duration or a predetermined factor. If, in contrast, the user feedback includes a waiting time between a point in time at which the charging station, contrary to the prediction, was occupied, and a later point in time at which the charging station became available, then the waiting time (which is a constituent element of the expected availability) can also be extended, e.g. by the waiting time from the user feedback, or the product of a predetermined factor and the waiting time from the user feedback.

In another embodiment, one or more of the pieces of availability information are stored on a central server or in a data cloud (cloud). Thus, the pieces of availability information may also be used for other vehicles, e.g. for vehicles whose users utilize a service for predicting the availability of charging stations. Analogously, the user feedback may also be stored on a central server or in a data cloud.

In another embodiment, the establishing of the expected time of arrival and/or the determination of the expected availability of the charging station are carried out with a data cloud service.

In another embodiment, several of the pieces of availability information are checked for patterns and/or connections using artificial intelligence when determining the expected availability of the charging station.

In another embodiment, the expected availability of the charging station is taken into account when computing a route for the vehicle.

For example, the availability is taken into account in the assessment of paths of a route graph ahead, e.g. by setting points of long or short waiting times, fines and/or efficiency points. An optimized prediction of the availability of charging stations along a route may also be used for a travel time prediction. Such a travel time prediction may also be used as a basis for a charging station reservation system. The more exact the prediction of an arrival is, the more efficiently time frames for the availability of charging stations can be assigned. Availability predictions of charging stations may thus be supplemented, or alternatively replaced, with booking information.

The driver assistance system according to the embodiment with which the above-mentioned object is also achieved is configured to establish an expected time of arrival of a vehicle at a charging station, and to determine an expected availability of the charging station at the time of arrival, wherein a user feedback about the correctness of a prediction of the availability of the charging station in the past is taken into account.

For this purpose, the driver assistance system includes, for example, an arrival time establishing unit, which is configured for establishing the time of arrival, and an availability determination unit configured for determining the availability of the charging station. The arrival time establishing unit may include a navigation unit or be coupled to a navigation unit. The availability determination unit may include a storage unit in which the user feedback is stored, or be coupled to such a storage unit. Optionally, the driver assistance system may include an output unit for outputting the availability of the charging station to a user, particularly to a driver of the vehicle.

The driver assistance system may be located aboard the vehicle or in a center. Alternatively, the driver assistance system may be part of a data cloud service. As a further alternative, constituent elements of the driver assistance system may be distributed among the vehicle, a center and/or a data cloud service.

The driver assistance system permits carrying out the method according to the various embodiments. Therefore, the advantages of the driver assistance system match the above-mentioned advantages of the method according to the disclosed embodiments.

With reference to Figures, the various embodiments are explained in more detail below. In the drawings:

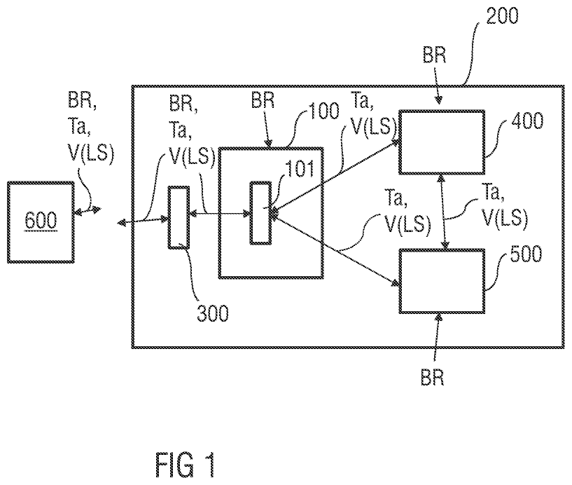

FIG. 1 shows a block diagram of the driver assistance system according to an embodiment.

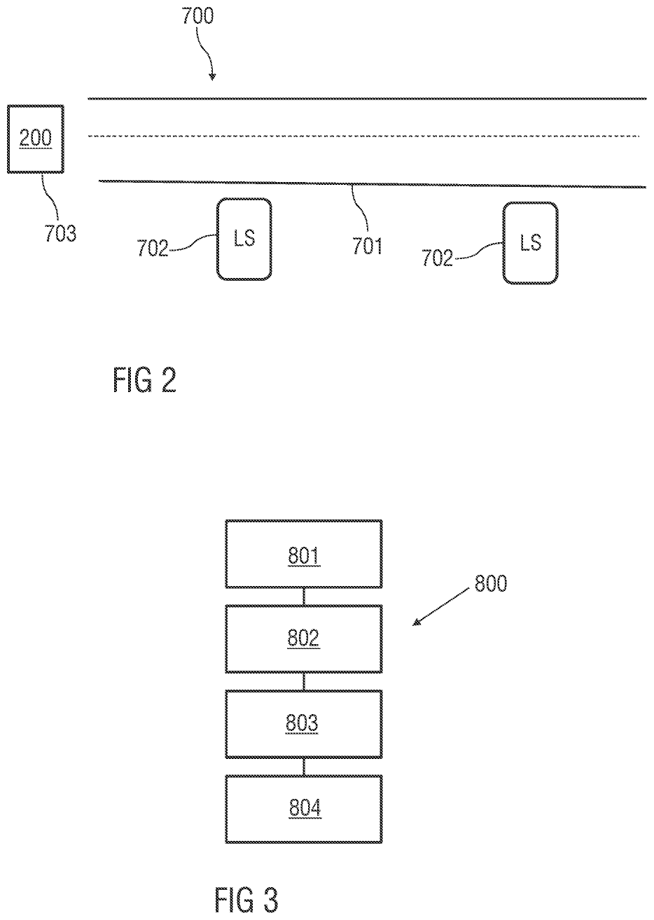

FIG. 2 shows a map section with visual pointers according to an embodiment,

FIG. 3 shows a flow chart of the method according to an embodiment.

FIG. 1 shows a block diagram of a driver assistance system 100 according to one embodiment.

The driver assistance system 100 is integrated into a vehicle 200 and configured for predicting the expected availability V(LS) of a charging station LS for the vehicle 200.

The vehicle 200 is approaching the charging station LS. The charging station LS may be one of several charging stations LS on a route ahead, or a charging station LS that can be approached specifically in the vicinity of a fixed location of the vehicle 200, e.g. in the vicinity of the residence or workplace of a user of the vehicle 200.

The driver assistance system 100 is configured to establish an expected time of arrival Ta of the vehicle 200 at the charging station LS, and to determine an expected availability V(LS) of the charging station LS at the time of arrival Ta taking into account a user feedback BR about the correctness of a prediction of the availability V(LS) of the charging station LS in the past.

For this purpose, the driver assistance system 100 includes a computing unit 101. The computing unit 101 serves as a control and analysis module of the driver assistance system 100. Apart from a processor (CPU, Central Processing Unit), the computing unit 101 has a working memory (RAM, Random Access Memory), which serves for the transitional storage of data D, pieces of information I, variables, and intermediate results.

The processor and the working memory are combined on an integrated circuit. Alternatively, the processor and the working memory may be arranged separately from each other, e.g. each on a different integrated circuit.

The computing unit 101 is configured as a separate control unit of the vehicle 200. Alternatively, the computing unit 101 may be implemented in an existing control unit, e.g. a navigation control unit. Apart from the computing unit 101, the driver assistance system 100 may include further functional units not shown in FIG. 1.

The computing unit 101 can execute an algorithm with which an expected time of arrival Ta of the vehicle 200 at the charging station LS can be established and an expected availability V(LS) of the charging station LS at the time of arrival Ta is determined taking into account one or several user feedbacks BR, each about the correctness of a prediction of the availability V(LS) of that charging station LS in the past.

In addition to taking into account the user feedback BR, which is externally supplied to the vehicle assistance system 100, for example, pieces of availability information in the form of vehicle data, charging station data and further stored and/or current data D, in particular sensor data and pieces of information I, may be taken into account when determining the expected availability V(LS) of the charging station LS.

For example, geographical data, such as road or route conditions, profiles, current traffic situations, current vehicle data, such as remaining vehicle range, charging state data of the vehicle battery, charging speed etc. may be determined as further relevant date D and pieces of information I. For example, these data D and pieces of information I may be detected and, if necessary, transmitted by vehicle-based and/or remote sensors, and/or be read out from vehicle-based storage devices and/or central servers.

For this purpose, the computing unit 101 is coupled in terms of signals and/or data to a communication interface 300, a destination guidance unit 400 and an operating unit 500, e.g. via a vehicle bus such as CAN (Controller Area Network).

For example, the communication interface 300 is configured as a radio interface, particularly as a GSM radio module (GSM, Global System for Mobile Communication), or as an optical interface. A unidirectional or a bidirectional data connection can be established with the communication interface 300. The computing unit 101 may be connected to a central server 600 or a data cloud service via the communication interface 300.

The destination guidance unit 400 may be configured for guiding the vehicle 200 along a route, particularly along a route ahead, which leads from a starting position to a target position. For this purpose, visual and acoustic destination guidance pointers based on the route are outputted to the user while the user steers the vehicle along the route.

The destination guidance unit 400 is connected to the operating unit 500 via a unidirectional data connection and provided, among other things, for displaying a map section with the route or a portion of the route. For this purpose, the destination guidance unit 400 has a map display unit, e.g. in the form of the above-mentioned touch screen, which at the same time is a part of the operating unit 500.

For example, the destination guidance unit 400 is configured for outputting pieces of visual maneuvering information, e.g. as direction arrows, to a user of the destination guidance unit 400. For this purpose, the destination guidance unit 400 has a maneuver display unit, for instance, which is disposed separately from the map display unit.

The maneuver display unit may include, among other things, a liquid crystal display (LCD), an OLED display (organic light emitting diode) or a head-up display. In another embodiment, the map display unit and the maneuver display unit are combined in a single module. The two units may then include a common screen or a common head-up display.

Moreover, the destination guidance unit 400 is configured for outputting acoustic destination guidance pointers to the user. For this purpose, the destination guidance unit 400 has a voice output unit having an audio amplifier and one or more loudspeakers. The voice output unit may be combined in a single module with the operating unit 500.

In order to take into account the route ahead of the vehicle 200 when determining the expected availability V(LS) of one of more charging station(s) LS ahead in a route requiring one charging stop or several charging stops, the computing unit 101 is coupled in terms of data and/or signals to the destination guidance unit 400.

The expected availability V(LS) of the one or several charging station(s) on the route ahead, which is determined by means of the computing unit 101, may be outputted, for example, directly to the operating unit 500 and/or indirectly via the destination guidance unit 400, in a visual and/or acoustic manner, to a user, e.g. to the driver of the vehicle 200, particularly while the user is steering the vehicle 200 along the route.

In addition to various pushbuttons, for example, the operating unit 500 has a voice input unit and a touch screen. As an addition to or alternative for one or more of the aforementioned components, the operating unit 500 may include a push/turn control knob and/or a touch pad. Among other things, the operating unit 500 serves for inputting operation commands and destinations into the destination guidance unit 400 by a user, and is connected to the computing unit 101 via a unidirectional data connection.

Moreover, a user feedback BR concerning the availability V(LS) of the charging station LS, which is transmitted to the computing unit 101 via a unidirectional or bidirectional data connection, can be inputted via the operating unit 500.

Moreover, the determined expected availability V(LS) at the potential time of arrival Ta can be used by the destination guidance unit 400 and taken into account in computing the route for approaching the available charging station LS along the route.

FIG. 2 shows, as an example, a map section 700 with visual pointers outputted by the driver assistance system 100 and/or the destination guidance unit 400 of the navigation device. Depicted is the case of the vehicle 200 driving along the route 701.

The visual destination guidance pointers include the depiction in the map section 700 of the course of the route 701, of the position 702 of the charging station LS, of the current vehicle position 703 of the vehicle 200, and of the expected availability V(LS) of the charging station LS established with the computing unit 101.

For example, the route 701 is depicted in a colored or otherwise highlighted manner. For example, the position 702 of the charging station LS is illustrated by a symbol of a charging station. For example, the expected availability V(LS) of the charging station LS is depicted in a colored or otherwise highlighted manner. If the charging station LS is available at the determined time of arrival Ta, the symbol of the charging station LS is shown in green. If the charging station LS is not available at the determined time of arrival Ta, the symbol of the charging station LS is shown in red.

The time of arrival Ta of the vehicle 200 at the charging station LS may be shown next to the symbol in the map section 700. The vehicle position 703 is illustrated by an arrow symbol that also symbolizes a current direction of movement of the vehicle.

If, based on current data D and/or pieces of information I, for instance concerning the status of the charging station LS and/or the traffic situation ahead, the computing unit 101 determines that the charging station LS is expected not to be freely available at the time of arrival Ta, the colored depiction of the symbol of the charging station LS is updated and adapted accordingly.

FIG. 3 shows a flow chart 800 of a method according to an embodiment. The method is being carried out using the driver assistance system 100 that was described with reference to FIG. 1.

In a first step 801 of the method, the driver assistance system 100 and, optionally, the destination guidance unit 400 are activated, e.g. by switching them on. A second method step 802 is carried out after the first method step 801.

In the second method step 802, a route 701 leading from a starting position to a target position is established with the driver assistance system 100 using the destination guidance unit 400. For this purpose, a user inputs a destination into the destination guidance unit 400 with the operating unit 500. Based on the destination, the target position is established with the destination guidance unit 400 using stored map data.

Alternatively, the target position may be established based on historical data, so that the target position is estimated. The starting position may also be derived from an input by the user. As an alternative, the starting position may be the current vehicle position 703. In addition, the position 702 or several positions 702 of charging stations LS along the route 701 are determined. A third method step 803 is carried out after the second method step 802.

In the third method step 803, an expected time of arrival Ta of the vehicle 200 at the charging station LS is determined, and an expected availability V(LS) of the charging station LS at the time of arrival Ta at the charging station LS is determined by means of the computing unit 101 of the driver assistance system 100, wherein at least one user feedback BR about the correctness of a prediction of the availability V(LS) of the charging station LS in the past is taken into account. A fourth method step 804 is carried out after the third method step 803.

In the fourth method step 804, visual and acoustic charging station pointers based on the route 701 are outputted to the user by means of the driver assistance system 100 while the user steers the vehicle along the route 701. For example, the expected availability V(LS) of the charging station LS and the time of arrival Ta at the charging station LS are visually and/or acoustically outputted as charging station pointers.

In order to determine the expected availability V(LS) of the one or the several charging station(s) LS, one or several pieces of information I, in particular pieces of availability information, which are currently being detected and/or stored, for example, are evaluated by means of the computing unit 101 in the third method step 803. For example,
an expected route and a charging state of another vehicle,
a current occupancy of the charging station LS,
a number of vehicles waiting at the charging station LS,
a waiting time of another vehicle and/or the own vehicle 200 at the charging station LS in the past,
a staying time of another vehicle and/or the own vehicle 200 at the charging station LS in the past,
a charging speed of the charging station LS, and/or
a number of charging points of the charging station LS are evaluated as pieces of availability information by means of the computing unit 101.

For this purpose, corresponding vehicle data and/or charging station data and/or pieces of information are detected and evaluated and optionally transmitted as data D and/or pieces of information I. For example, these vehicle data and/or charging station data/pieces of charging station information may be detected and stored locally and/or centrally in a continuous and up-to-date manner and/or for the past.

For example, an actual state of the availability V(LS) of individual charging stations LS of a charging station network may be determined as the information I and taken into account in the determination of the expected charging availability V(LS) of the charging station LS along the route. In particular, the expected availability V(LS) for the charging station LS that is ahead on the route at a suitable distance or that is the closest is determined in the process.

This actual state of the availability V(LS) of a charging station LS or of several charging stations LS of a charging station network along the route may be permanently detected and analyzed. For example, this condition monitoring is carried out centrally with a central server 600, which then transmits the corresponding pieces of information I and/or data D to the driver assistance system 100 via the communication interface 300.

In the process, the central server 600 may also acquire, for example, vehicle data of other third-party vehicles registered in a corresponding charging station network service, such as the charging state of a waiting third-party vehicle at the respective charging station LS, previous and/or current waiting time at the respective charging station LS, current route of the own vehicle 200, the user feedback BR, in particular concerning route plausibility and quality of the accuracy of the prediction, and transmit them to the driver assistance system 100.

The actual waiting time until the start of a charging process is determined by centrally acquiring the data D and/or pieces of information I of the own vehicle 200 and, optionally, of third-party vehicles that wait at the charging station LS ahead, for example. Positional data, route information, charging states and remaining range of the third-party vehicle and/or of the own vehicle 200 are determined and used for identifying the state of “waiting” for a third-party vehicle and/or of the own vehicle 200. Moreover, the availability status information of all charging stations LS may be permanently acquired, stored and analyzed.

These vehicle data and/or charging station data/pieces of charging station information, such as the charging speed, may also be retrieved, downloaded and/or transmitted to the driver assistance system 100, particularly its computing unit 101, from various data and/or information sources. The transmission may be carried out via the communication interface 300, in particular wirelessly via a radio link. The above-mentioned data may be transmitted in the third method step 803 by the central server 600 and/or the operating unit 500 and/or the destination guidance unit 400.

For example, a piece of information I indicating whether the charging station LS was available at a point in time at which the charging station LS was supposed to be available according to the prediction is supplied as a user feedback BR to the driver assistance system 100 or determined by the latter in the third method step 803. Such a predicted and actual availability of the charging station LS may then be taken into account when determining the prediction of the availability V(LS) of the charging station LS, whereby the quality of the prediction of the availability is improved.

Alternatively or additionally, the user feedback BR may include a waiting time between a point in time at which the charging station LS, contrary to the prediction, was occupied, and a later point in time at which the charging station LS became available. With respect to the waiting time, an actual waiting time may be taken into account. If there are several user feedbacks BR concerning waiting times, an average waiting time may be determined based on the reported waiting times and taken into account. In particular, average waiting times between the arrival and the completion of at least one or more executed charging processes of vehicles at the respective charging station LS in the past are taken into account in the current prediction of the availability V(LS) of that charging station LS.

Moreover, the user feedback BR may include one or more user feedbacks concerning a route plausibility and/or quality of the accuracy of the prediction of the respective charging station LS and, if necessary, further charging stations LS along the planned route. Moreover, the route plausibility and/or quality of the accuracy of the prediction may be used for weighting the reported waiting time(s) and/or average waiting time(s), wherein a weighted waiting time and/or weighted average waiting time is taken into account when predicting the availability of the respective charging station.

Furthermore, an expected waiting time between the time of arrival Ta and a later point in time at which the charging station LS is expected to become available can be determined and outputted as the expected availability V(LS) of the charging station LS.

Moreover, availability status information of the respective charging station LS and/or of further or all charging stations LS along the planned route 701 may be permanently acquired, stored and analyzed in the third method step 803. For this purpose, for example, the data D of vehicles that were already charged at one or several of the charging stations LS and the data D of the charging stations LS along the planned route 701 are combined and/or checked for patterns and connections and, if necessary, classified. Such classified vehicle data and/or charging station data can be taken into account in the prediction of the availability V(LS) of the respective charging station LS in the third method step 803.

In another embodiment, one or more of the pieces of availability information are stored on the central server 600 or in a data cloud. These centrally available data D and/or pieces of information I are supplied to the driver assistance system 100, particularly the computing unit 101, in the third method step 803.

These supplied, centrally stored pieces of availability information are evaluated and processed by the computing unit 101 in the third method step 803, and are then, in the fourth method step 804, made available to the user or further users, particularly of other vehicles or third-party vehicles, or retrieved by them.

Furthermore, several of the pieces of availability information can be checked for patterns and/or connections using artificial intelligence in the third method step 803 when determining the expected availability V(LS) of the charging station LS, wherein the results of the check are taken into account in the prediction of the availability V(LS), and the quality of the prediction is thus improved.

In another embodiment, the data D of the vehicles and the charging stations LS are combined and checked for patterns and/or connections, in particular by using artificial intelligence. Moreover, the charging station LS may be classified and/or graded based on the results of the check. In this way, the charging stations LS that lie ahead on a route 701 may be classified and/or graded, for example. The classification and/or grading of the charging stations LS is taken into account in the prediction of the availability V(LS) of the charging stations LS in the third method step 803.

For example, the prediction of the availability V(LS) of charging stations LS is represented in the assessment of paths or routes 701 of a route graph ahead, by setting points of long or short waiting times, fines and/or efficiency points. An optimized prediction of the availability V(LS) of charging stations LS along a route 701 may also be used for a travel time prediction. Such a travel time prediction may also be used as a basis for a charging station reservation system.

In another embodiment, the expected availability V(LS) of the charging station LS is taken into account when computing a route 701 for the vehicle in the second method step 802. Particularly in the case of longer routes 701 with several charging stops, this embodiment permits an improved and optimized planning of the charging stops, whereby the travel time can be optimized and, in particular, shortened.

1. A method for predicting the availability of a charging station for a vehicle with a driver assistance system, in which the following method steps are carried out:
establishing an expected time of arrival of the vehicle at the charging station, and
determining an expected availability of the charging station at the time of arrival Ta, wherein at least one user feedback about the correctness of a prediction of the availability of the charging station in the past is taken into account.

2. The method according to claim 1, wherein determining the expected availability of the charging station further comprises:
evaluating one or more of the following pieces of availability information:
an expected route and a charging state of another vehicle,
a current occupancy of the charging station,
a number of vehicles waiting at the charging station,
a waiting time of a vehicle at the charging station in the past,
a staying time of a vehicle at the charging station in the past,
a charging speed of the charging station,
a number of charging points of the charging station.

3. The method according to claim 2, wherein the user feedback includes the piece of information about whether the charging station was available at a point in time at which the charging station was supposed to be available according to the prediction.

4. The method according to claim 1, wherein the user feedback includes a waiting time between a point in time at which the charging station, contrary to the prediction, was occupied, and a later point in time at which the charging station became available.

5. The method according to claim 2, wherein the expected availability of the charging station includes an expected waiting time between the time of arrival and a later point in time at which the charging station is expected to become available.

6. The method according to claim 2, wherein one or more of the pieces of availability information are stored on a central server or in a data cloud.

7. The method according to claim 1, wherein the establishing of the expected time of arrival and/or the determination of the expected availability of the charging station are carried out with a data cloud service.

8. The method according to claim 2, wherein several of the pieces of availability information are checked for patterns and/or connections using artificial intelligence when determining the expected availability of the charging station.

9. The method according to claim 1, wherein the expected availability of the charging station is taken into account when computing a route for the vehicle.

10. A driver assistance system for predicting the availability of a charging station for a vehicle, wherein the driver assistance system is configured to:
establish an expected time of arrival of the vehicle at the charging station, and
determine an expected availability of the charging station at the time of arrival, wherein a user feedback about a correctness of a prediction of the availability of the charging station in the past is taken into account.
